(19) United States
(12) Patent Application Publication
(10) Pub. No.: US 2019/0271141 A1
(43) Pub. Date: Sep. 5, 2019

(54) Wireless Foot-operated Stop Valve

(71) Applicant: Ronald David Green, Santa Cruz, CA (US)

(72) Inventor: Ronald David Green, Santa Cruz, CA (US)

(21) Appl. No.: 15/912,351

(22) Filed: Mar. 5, 2018

(51) Int. Cl. E03C 1/05; F16K 31/46; F16K 31/62

(52) U.S. Cl. CPC E03C 1/052; F16K 31/46; G05G 1/46; E03C 1/057; F16K 31/62

(57) ABSTRACT

A water-control system has a faucet, a base unit having at least one normally-open solenoid-operated valve coupled to a water inlet fitting and a water outlet fitting, control circuitry, and a first antenna, and an elongated foot switch, having a normally-open contact element, a battery, and circuitry including a second antenna. A water-supply conduit is coupled to the water-inlet fitting of the solenoid-operated valve, and a water line is connected between the water-outlet fitting of the solenoid-operated valve and a fitting at the adjustable faucet, and wherein, with the faucet open and water flowing from the faucet, stepping on the foot switch closes the normally-open contact element, causing a signal to be sent wirelessly from the elongated foot switch to the solenoid control circuitry, causing the solenoid-operated valve to close, stopping water flow from the faucet, and releasing the foot switch allows water flow to resume.

### BACKGROUND OF THE INVENTION

### 1. Field of the Invention

The present invention is in the technical area of plumbing equipment, and pertains more particularly to control of hot and cold water associated with faucets and sinks.

### 2. Description of Related Art

Foot pedals for water control are well-known in the art. There were twenty-two US patents granted in this area between 1991 and 2017, with many earlier examples. The purpose of these devices is to control water flow using the feet, in order to achieve goals of sanitary operation and water conservation.

The dispensing aspect of prior designs is important when examining prior art. A typical sink faucet may be considered a dispensing device: the default state of the mechanism is off, and the user engages the device (i.e., opens a valve) to get water. Similarly, a foot-pedal device is a dispensing mechanism: the user engages the device (i.e., steps on a switch or pedal) to get water. The basic function of dispensing is the defining characteristic of all faucets, including those that are manually operated (by hand), foot-operated, and electronic or sensor-based.

In contrast, a foot-operated stop valve is not a dispensing mechanism. The purpose of a foot-operated stop valve is to interrupt the flow of water, not enable it. The design is implemented with normally-open (N.O.) valves. These are valves that are open in their default state, allowing water to flow. Engaging the device (stepping on the switch) closes the valves and suspends (temporarily stops) the flow of water. This design for suspending flow is the defining characteristic of the foot-operated stop valve, and differentiates it from dispensing mechanisms.

A review of prior art by the inventor, including US and foreign patents, commercial products, and online resources has revealed no other foot-operated devices designed to achieve a suspend function. This function is described only in U.S. Pat. No. 5,511,763, issued to the present inventor in 1996. The device described and claimed in U.S. Pat. No. 5,511,763 has some drawbacks, which are remedied by elements and functions of the present invention.

### BRIEF SUMMARY OF THE INVENTION

In one embodiment of the invention a water-control system is provided, comprising an adjustable faucet, a base unit having at least one normally-open solenoid-operated valve coupled to a water inlet fitting and a water outlet fitting, solenoid control circuitry coupled to the solenoid, comprising power-switching elements, and a first antenna receiving signals wirelessly for solenoid control, and an elongated foot switch of at least twelve inches in length, having a normally-open contact element, a battery, and circuitry including a second antenna sending signals wirelessly for solenoid control. A water-supply conduit is coupled to the water-inlet fitting of the solenoid-operated valve, and a water line is connected between the water-outlet fitting of the solenoid-operated valve and a fitting at the adjustable faucet, and wherein, with the faucet open and water flowing from the faucet, stepping on the foot switch closes the normally-open contact element, causing a signal to be sent wirelessly from the elongated foot switch to the solenoid control circuitry, causing the solenoid-operated valve to close, stopping water flow from the faucet, and releasing the foot switch allows water flow to resume.

In one embodiment the system further comprises a second normally-open solenoid-operated valve having a second water line connected to a water-inlet fitting of the second solenoid-operated valve and a water line connected from a water outlet fitting of the second solenoid-operated valve to a second fitting at the adjustable faucet, one water line being cold water, and the other hot water. Also in one embodiment the foot switch comprises a battery powering the circuitry of the foot switch. In one embodiment the system further comprises water hammer arrestors in-line with each of the solenoid-operated valves. And in one embodiment, the system further comprises a vanity having a sink receptacle accommodating the faucet, wherein the base unit is installed in the vanity, and is powered by a conversion-adapter power supply, converting 120 V AC power to power required by the base unit.

In one embodiment of the system the foot switch comprises an upper elongated element and a lower elongated element, separated by one or more compression springs, with the normally-open contact element between the upper and the lower elongated elements, such that the normally-open contact element is closed by urging the upper element against pressure of the compression springs toward the lower element. And in one embodiment, the foot switch has a lower element constrained on a supporting surface by one of hook-and-loop fasteners, or by conventional hardware fasteners.

In another aspect of the invention a water-control method is provided, comprising installing a base unit having at least one normally-open solenoid-operated valve in a vanity having a sink receptacle and an adjustable faucet, coupling a water inlet line to a water inlet fitting of the solenoid-operated valve and coupling a water line between a water outlet fitting of the solenoid-operated valve and the faucet, installing an elongated foot switch of at least twelve inches in length, having a normally-open contact element, a battery, and circuitry including a second antenna sending signals wirelessly for solenoid control, on a floor surface in front of the vanity, the elongated floor switch parallel to a front of the vanity, closing the normally-open contact element by stepping on the foot switch, causing a wireless signal to be sent to the base unit, and receiving the wireless signal at the base unit by solenoid control circuitry, causing the normally-open solenoid-operated valve to close, stopping water flow to the faucet.

In one embodiment the method further comprises a second solenoid-operated valve having a second water line connected to a water-inlet fitting of the second solenoid-operated valve and a water line connected from a water outlet fitting of the second solenoid-operated valve to a second fitting at the adjustable faucet, one water line being cold water, and the other hot water, wherein stepping on the foot switch stops water flow through both solenoid-operated valves. Also in one embodiment, the foot switch comprises a battery powering the circuitry of the foot switch. Also in one embodiment, the method further comprises water hammer arrestors in-line with each of the solenoid-operated valves. Also in one embodiment the method further comprises a conversion-adapter power supply, converting 120 V AC power to power required by the base unit. In one embodiment the foot switch comprises an upper elongated element and a lower elongated element, separated by one or more compression springs, with the normally-open contact element between the upper and the lower elongated elements, such that the normally-open contact element is closed by urging the upper element against pressure of the compression springs toward the lower element. And in one embodiment the foot switch has a lower element constrained on a supporting surface by one of hook-and-loop fasteners, or by conventional hardware fasteners.

### BRIEF DESCRIPTION OF THE SEVERAL VIEWS OF THE DRAWINGS

FIG. 1 shows system components installed in a typical sink vanity cabinet, in an embodiment of the invention.

FIG. 2 shows a circuit diagram in one embodiment for a solenoid controller.

FIG. 3 shows a circuit diagram in one embodiment for a foot switch transmitter.

### DETAILED DESCRIPTION OF THE INVENTION

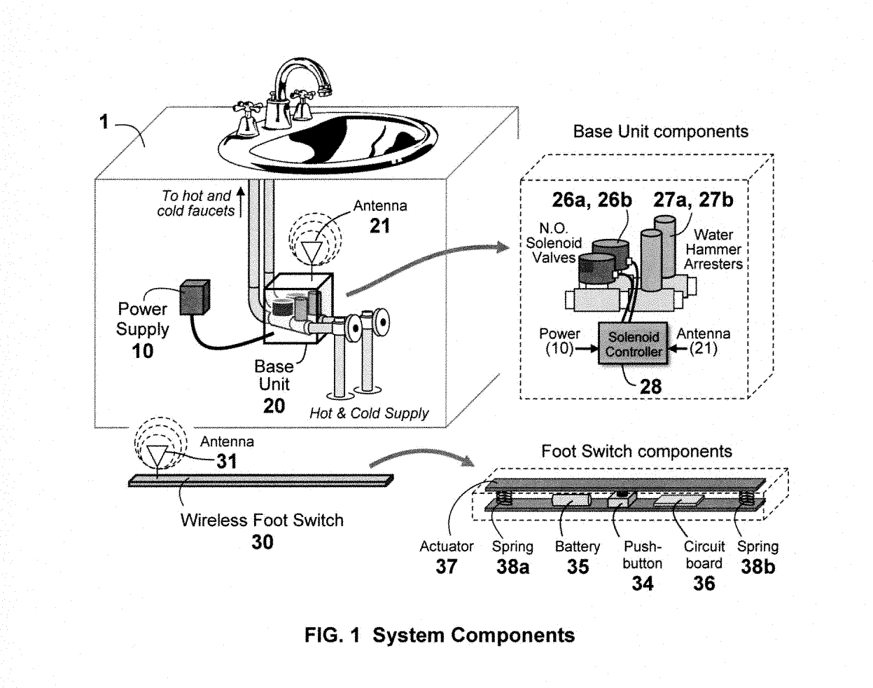

FIG. 1 shows major components of the system in one embodiment. A base unit 20, comprising a plurality of components described below, is installed under a sink in a typical vanity cabinet 1, and is inserted in the water supply lines between the shutoff valves and the faucet, by connecting incoming hot-water and cold-water lines to the base unit, and connecting outlets of the base unit to lines proceeding to the faucet components of the vanity.

Base unit 20 comprises two normally-open solenoid valves, plus two water hammer arresters. Water hammer arresters are used to suppress a loud bang that occurs when a solenoid closes too quickly, interrupting water flow. In this implementation solenoid 26a is connected to arrester 27a, and solenoid 26b is connected to arrester 27b, as shown in an expanded view of the base unit, labeled Base Unit Components, in FIG. 1. Base unit 20 also comprises a solenoid controller circuit board 28 which drives the solenoids and connects to a power supply 10. An antenna 21 is shown symbolically, as it is actually a short length of wire on the circuit board.

Base unit 20 is powered by power supply 10, which is a standard adapter that converts residential AC (110-220 volts) to low-voltage DC (12-24 volts.)

Foot switch 30 in one embodiment is a standalone unit that sits on the floor in front of the vanity cabinet. Foot switch 30 in this embodiment is an elongated assembly enabling, by the length, a person to step on the switch to operate the base unit, without need for looking at the floor for the switch. In one embodiment foot switch 20 is about twelve inches in length. Foot switch comprises in one embodiment circuit board 36, battery 35, and a momentary-contact pushbutton 34. Antenna 31 is shown symbolically, as it is actually a short length of wire on the circuit board, not a separate physical component. The foot switch uses elongated actuator 37 supported by springs 38a and 38b, to activate the momentary-contact pushbutton. The elongated actuator provides a wide target that is easy to find with the feet.

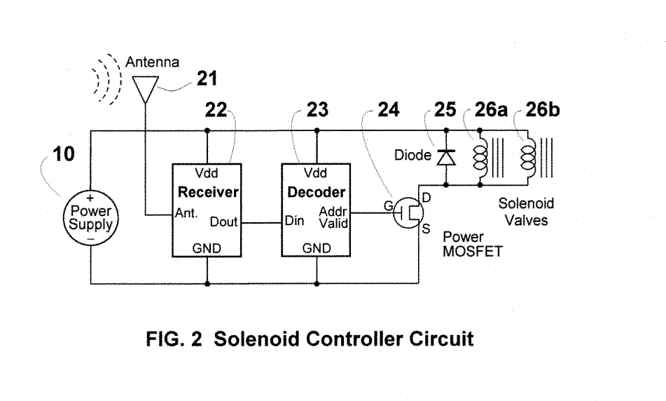

FIG. 2 shows a circuit diagram in one embodiment for solenoid controller 28, which comprises antenna 21, receiver module 22, decoder module 23, power MOSFET transistor 24, flyback diode 25, and solenoid valves (inductive loads) 26a and 26b.

MOSFET transistor 24 is used to turn on the solenoids. Flyback diode 25 (a.k.a. snubber, kickback, etc.) is used to eliminate a voltage spike that occurs across an inductive load when the power is cut. This combination of a power transistor and diode to control solenoids is a widely used practice.

Receiver module 22 in this embodiment is a commercially-available radio-frequency (RF) mini-PCB designed to detect Amplitude Shift Keying (ASK) modulated signals in the 433 MHz (or 315 MHz) band. Similarly, the decoder module is a commercially available integrated circuit (IC) designed to de-serialize a data stream (bit-stream) and decode an address. The receiver and decoder are designed to work as a set. The receiver generates a bit-stream for the decoder which is looking for a valid address. If the correct address is detected, the IC outputs a logic true signal on its “Addr Valid” pin. A valid address enables the MOSFET and energizes the solenoids.

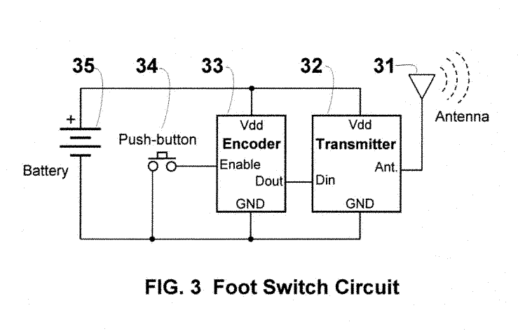

FIG. 3 shows a circuit diagram for wireless foot switch 30 in one embodiment. Foot switch 30 in this embodiment comprises antenna 31, encoder module 33, transmitter module 32, momentary-contact pushbutton 34, and battery 35. Encoder module 33 is a commercially-available integrated circuit designed for low-voltage, remote-control applications. Similarly, transmitter module 32 is a commercially-available RF mini-PCB that broadcasts a low-power ASK-modulated signal in a 433 Mhz (or 315 Mhz) band. The encoder and transmitter modules are designed to work as a set: the encoder outputs a serialized bit-stream that carries an address. This signal is input to the ASK transmitter and turned into a modulated broadcast signal. The encoder is triggered when push-button 34 closes. The encoder and transmitter modules are designed for low voltage (e.g., 3 volts or less).

The skilled person will understand that the descriptions above are for modules and equipment that is exemplary in nature, not limiting, and that there are a variety of changes that might be made within the scope of the invention. The length, for example of the floor foot switch may vary, as long as it is long enough to accommodate the stance of a user, who may choose to use either foot to activate the system. There are a variety of solenoid valves that may work as well, and wireless operation may be accomplished in other ways than the examples described. For example, in one embodiment there may be just one solenoid-operated valve in the base unit, controlling just one water passage, for use in systems that do not accommodate both hot and cold water supply. There are many other changes that may be made within the scope of the invention. The invention is limited only by the claims that follow.

1. A water-control system, comprising:
an adjustable faucet;
a base unit having at least one normally-open solenoid-operated valve coupled to a water inlet fitting and a water outlet fitting, solenoid control circuitry coupled to the solenoid, comprising power-switching elements, and a first antenna receiving signals wirelessly for solenoid control; and
an elongated foot switch of at least twelve inches in length, having a normally-open contact element, a battery, and circuitry including a second antenna sending signals wirelessly for solenoid control;
wherein a water-supply conduit is coupled to the water-inlet fitting of the solenoid-operated valve, and a water line is connected between the water-outlet fitting of the solenoid-operated valve and a fitting at the adjustable faucet, and wherein, with the faucet open and water flowing from the faucet, stepping on the foot switch closes the normally-open contact element, causing a signal to be sent wirelessly from the elongated foot switch to the solenoid control circuitry, causing the solenoid-operated valve to close, stopping water flow from the faucet, and releasing the foot switch allows water flow to resume.

2. The water-control system of claim 1 further comprising a second normally-open solenoid-operated valve having a second water line connected to a water-inlet fitting of the second solenoid-operated valve and a water line connected from a water outlet fitting of the second solenoid-operated valve to a second fitting at the adjustable faucet, one water line being cold water, and the other hot water.

3. The water-control system of claim 2 wherein the foot switch comprises a battery powering the circuitry of the foot switch.

4. The water-control system of claim 2 further comprising water hammer arrestors in-line with each of the solenoid-operated valves.

5. The water-control system of claim 2 further comprising a vanity having a sink receptacle accommodating the faucet, wherein the base unit is installed in the vanity, and is powered by a conversion-adapter power supply, converting 120 V AC power to power required by the base unit.

6. The water-control system of claim 2 wherein the foot switch comprises an upper elongated element and a lower elongated element, separated by one or more compression springs, with the normally-open contact element between the upper and the lower elongated elements, such that the normally-open contact element is closed by urging the upper element against pressure of the compression springs toward the lower element.

7. The water-control system of claim 2 wherein the foot switch has a lower element constrained on a supporting surface by one of hook-and-loop fasteners, or by conventional hardware fasteners.

8. A water-control method, comprising:
installing a base unit having at least one normally-open solenoid-operated valve in a vanity having a sink receptacle and an adjustable faucet;
coupling a water inlet line to a water inlet fitting of the solenoid-operated valve and coupling a water line between a water outlet fitting of the solenoid-operated valve and the faucet;
installing an elongated foot switch of at least twelve inches in length, having a normally-open contact element, a battery, and circuitry including a second antenna sending signals wirelessly for solenoid control, on a floor surface in front of the vanity, the elongated floor switch parallel to a front of the vanity;
closing the normally-open contact element by stepping on the foot switch, causing a wireless signal to be sent to the base unit; and
receiving the wireless signal at the base unit by solenoid control circuitry, causing the normally-open solenoid-operated valve to close, stopping water flow to the faucet.

9. The water-control method of claim 8 further comprising a second solenoid-operated valve having a second water line connected to a water-inlet fitting of the second solenoid-operated valve and a water line connected from a water outlet fitting of the second solenoid-operated valve to a second fitting at the adjustable faucet, one water line being cold water, and the other hot water, wherein stepping on the foot switch stops water flow through both solenoid-operated valves.

10. The water-control method of claim 9 wherein the foot switch comprises a battery powering the circuitry of the foot switch.

11. The water-control method of claim 9 further comprising water hammer arrestors in-line with each of the solenoid-operated valves.

12. The water-control method of claim 9 further comprising a conversion-adapter power supply, converting 120 V AC power to power required by the base unit.

13. The water-control method of claim 9 wherein the foot switch comprises an upper elongated element and a lower elongated element, separated by one or more compression springs, with the normally-open contact element between the upper and the lower elongated elements, such that the normally-open contact element is closed by urging the upper element against pressure of the compression springs toward the lower element.

14. The water-control method of claim 9 wherein the foot switch has a lower element constrained on a supporting surface by one of hook-and-loop fasteners, or by conventional hardware fasteners.
